(19) United States
(12) Patent Application Publication
(10) Pub. No.: US 2003/0016286 A1
(43) Pub. Date: Jan. 23, 2003

(54) Device for installing wireless video and audio transmitter in a soft housing

(76) Inventors: Chun-Fang Liu, Hsin-Shi (TW); Lung-Chin Chen, Hsin-Shi (TW)

Correspondence Address: Keith Kline, PRO-TECHTOR INTERNATIONAL SERVICES, 20775 Norada Court, Saratoga, CA, 95070-3018, US

(21) Appl. No.: 09/909,726

(22) Filed: Jul. 19, 2001

(51) Int. Cl. H04N 7/18

(52) U.S. Cl. 348/143; 348/61; 348/151

(57) ABSTRACT

A device for installing wireless video and audio transmitter in a soft housing comprises the following components. A supporter is installed in the soft housing, the supporter being formed by a metal plate of high heat conductivity for supporting the soft housing. A sensor is fixed to the supporter for generating video signals. A microphone is fixed to the surface of the soft housing for generating audio signals. A main circuit board is fixed to the supporter and has a RF module fixed thereon. The RF module serves for transmitting the audio and video signals to a receiver through the antenna. The power box is positioned in the soft housing for providing DC power.

### FIELD OF THE INVENTION

The present invention relates to a device for installing wireless video and audio transmitter in a soft housing, in particular a device which includes a supporter installed in the soft housing, the supporter being formed by a metal plate of high heat conductivity for supporting the soft housing to have a fixed shape and increasing the heat dissipating effect.

### BACKGROUND OF THE INVENTION

Monitoring system is popular in prior art, but has a defect that it must be installed with many circuits and devices, and moreover, the monitor system is fixed and has a larger volume, thereby, easily being discovered. Therefore, some improved structures are found, such as European patent application number 99300704.6, “Audio/video monitoring system”, in that a camera and a video and audio transmitting device are installed in a doll. However, such a structure has no heat dissipating structure, thereby, the camera and transmitter being easily destroyed due to high temperature.

### SUMMARY OF THE INVENTION

Accordingly, the primary object of the present invention is to provide a device for installing wireless video and audio transmitter in a soft housing, wherein the device can be placed anywhere and is difficult to be discovered.

Another object of the present invention is to provide a device for installing wireless video and audio transmitter in a soft housing, wherein the device has an improved heat dissipating ability.

To achieve above object, the present invention provides a device for installing wireless video and audio transmitter in a soft housing, comprising:

a supporter being located in said soft housing, said supporter being formed by a metal plate of high heat conductivity for supporting said soft housing to have a fixed shape and increasing the heat dissipating effect;

a sensor fixed to said supporter for generating video signals; wherein said video signals are transferred to a main circuit board by a connecting wire;

a microphone fixed to the surface of said soft housing for generating audio signals;

wherein said audio signals are transferred to said sensor and then transferred to said main circuit board;

said main circuit board fixed to said supporter and having a RF module fixed thereon; said main circuit board being connected to said sensor, an antenna and a power box;

said RF module serving for transmitting said video signals and audio signals to a receiver through said antenna; and

said power box being positioned in said soft housing for providing power.

Preferably, the supporter is formed in [symbol] -like shape; a front edge of an upper end thereof is installed with a hollow rectangular frame vertically arranged, thereby said sensor protrudes from said hollow rectangular frame to be fixed therein, said main circuit board is fixed to the middle vertical plate of said supporter.

Preferably, the soft housing is a doll, wherein said doll has the form of an animal or human figure, said sensor being located in the nose of said doll, said antenna being located in the upper limb of said antenna and said power box being located in the lower limb of said doll.

The various objects and advantages of the present invention will be more readily understood from the following detailed description when read in conjunction with the appended drawing.

### BRIEF DESCRIPTION OF THE DRAWINGS

FIG. 1 is a perspective view of an embodiment of the present invention.

FIG. 2 is a front perspective view of the embodiment of the present invention.

FIG. 3 is a lateral perspective view of the embodiment in the present invention.

FIG. 4 is an exploded perspective view of the embodiment in the present invention.

### DETAILED DESCRIPTION OF THE INVENTION

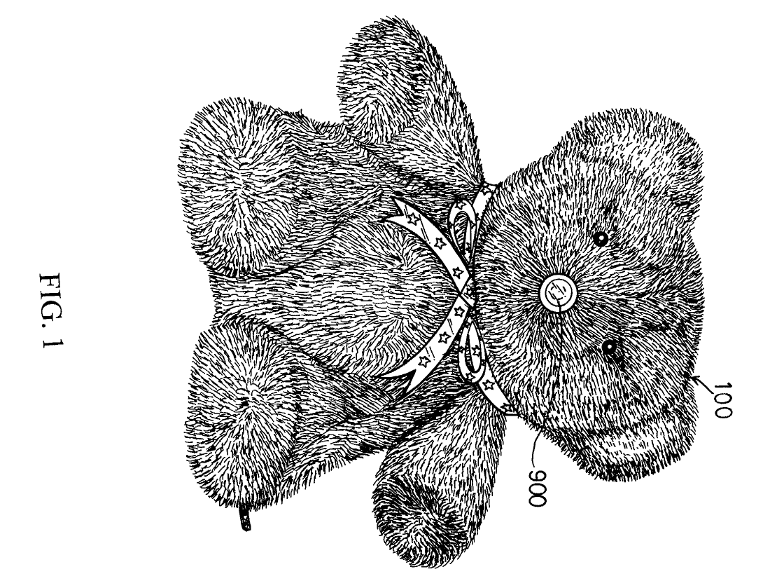

Referring to FIG. 1, a perspective view of the bear doll of the present invention is illustrated. In the embodiment, only the doll 100 is protruded from the lens 900. Not only the monitor system cannot be found easily, but also the position of the doll 100 can be placed as desired.

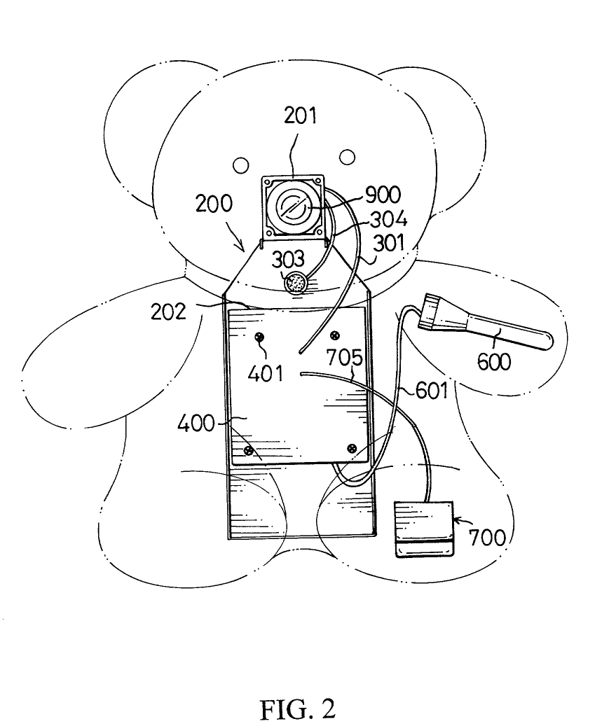

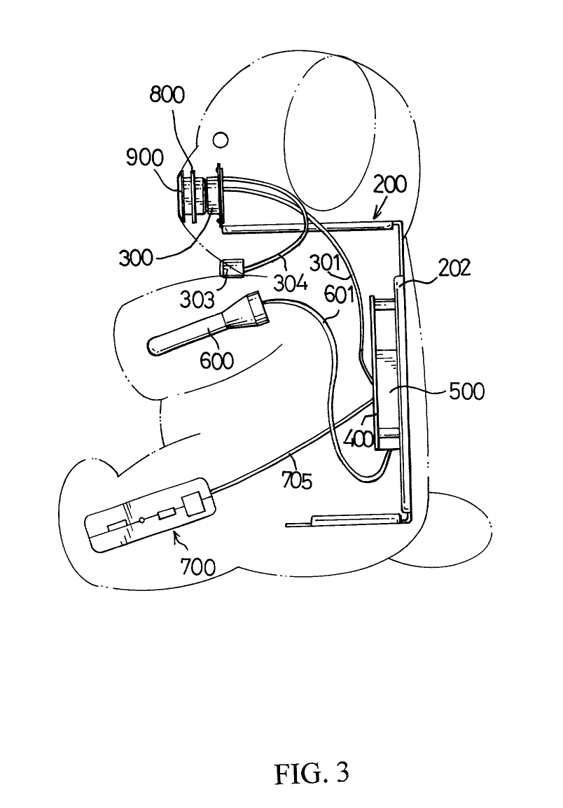

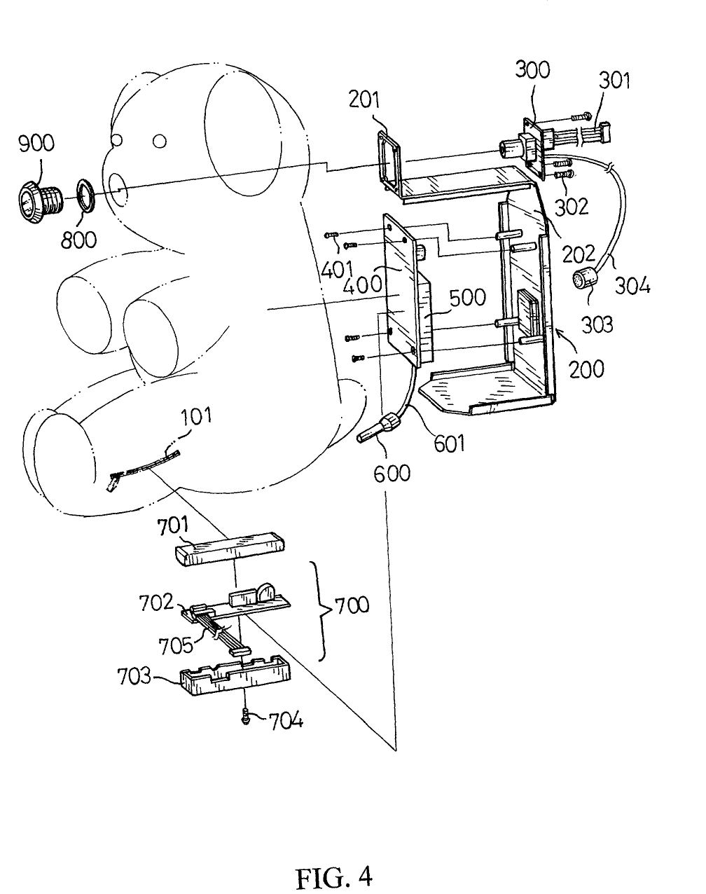

With reference to FIGS. 2, 3 and 4, the present invention includes a supporter 200 within the doll 100 and is made of plate metal with preferred heat conductivity so as to support the doll 100 to have a fixed shape and have a preferred heat dissipating effect. The supporter is formed in [symbol] -like shape. The front edge of the upper end of the supporter has a vertical hollow rectangular frame 201 for protruding the sensor 300 to be fixed thereon. The main circuit board 400 is fixed to a middle vertical plate 202 of the supporter 200.

A sensor 300 is fixed to the hollow rectangular frame 201 of the supporter 200 by screws 302 for generating video signals. The video signals are sent to the main circuit board 400 by the connecting wire 301.

A microphone 303 is fixed to the surface of the doll 100 for generating audio signals. The audio signals are sent to the sensor 300 through the connecting wire 304 and then sent to the main circuit board 400 through the connecting wire 301.

A main circuit board 400 is fixed to the middle vertical plate 202 of the supporter 200 by screws 401, a RF module 500 being installed on the main circuit board 400. The main circuit board 400 is connected to the sensor 300 through the connecting wire 301, to an antenna 600 through a connecting wire 601, and to a power box 700 through a connecting wire 705.

The RF module 500 serves to send out the video signals and audio signals to a receiver (not shown) through the antenna 600.

The power box 700 serves to provide DC current and is installed by an upper cover 703, a lower cover 701 and a power circuit board 702. These three components are locked by screws 704.

A hard ring 800 is fixed to a nose of the doll 100, thereby, a lens 900 being capable of being pressed into said hard ring 800 to be fixed therein.

After assembling above components of the present invention, the sensor 300 is placed into the doll 100 from the zipper (not shown) at the back side of the doll 100 so that the sensor 300 is at the nose of the doll 100, and lens 900 is pressed into the hard ring 800 to be fixed thereon. Besides, the antenna 600 is at the upper limb of the doll 100. The power box 700 is at the lower limb of the doll 100. The user is only necessary to open the zipper 101 for taking the power box 700 out.

From the invention thus described, it will be obvious that this invention as described above is provided for explanation and that the invention may be varied in many ways, where such variations are not to be regarded as departing from the spirit and scope of the invention, and all such modifications as would be obvious to one skilled in the art are intended for inclusion within the scope of the following claims.

What is claimed is:

1. A device for installing wireless video and audio transmitter in a soft housing, comprising:
a supporter being located in said soft housing, said supporter being formed by a metal plate of high heat conductivity for supporting said soft housing to have a fixed shape and increasing the heat dissipating effect;
a sensor fixed to said supporter for generating video signals; wherein said video signals are transferred to a main circuit board by a connecting wire;
a microphone fixed to the surface of said soft housing for generating audio signals; wherein said audio signals are transferred to said sensor and then transferred to said main circuit board;
said main circuit board fixed to said supporter and having a RF module fixed thereon; said main circuit board being connected to said sensor, an antenna and a power box;
said RF module serving for transmitting said video signals and audio signals to a receiver through said antenna; and
said power box being positioned in said soft housing for providing power.

2. The device for installing wireless video and audio transmitter in a soft housing as claimed in claim 1, wherein said supporter being formed in [symbol] -like shape; a front edge of an upper end thereof is installed with a hollow rectangular frame vertically arranged, thereby said sensor protrudes from said hollow rectangular frame to be fixed therein, said main circuit board is fixed to the middle vertical plate of said supporter.

3. The device for installing wireless video and audio transmitter in a soft housing as claimed in claim 2, further comprising:
a hard ring being fixed to said soft housing near the surface thereof; thereby, a lens being capable of being pressed into said hard ring to be fixed therein.

4. The device for installing wireless video and audio transmitter in a soft housing as claimed in claim 3, wherein said power box provides DC power and is formed by an upper cover, a lower cover and a power circuit board.

5. The device for installing wireless video and audio transmitter in a soft housing as claimed in claim 4, wherein said soft housing is a doll.

6. The device for installing wireless video and audio transmitter in a soft housing as claimed in claim 5, wherein said doll has the form of an animal or human figure, said sensor being located in the nose of said doll, said antenna being located in the upper limb of said antenna and said power box being located in the lower limb of said doll.
